(19) United States
(12) Patent Application Publication
(10) Pub. No.: US 2010/0134508 A1
(43) Pub. Date: Jun. 3, 2010

(54) INFORMATION PROCESSING APPARATUS, INFORMATION PROCESSING METHOD, AND STORAGE MEDIUM

(75) Inventor: Hideo Kuboyama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/625,942

(22) Filed: Nov. 25, 2009

(30) Foreign Application Priority Data
Nov. 28, 2008 (JP) 2008-304599

(51) Int. Cl. G09G 5/00

(52) U.S. Cl. 345/581

(57) ABSTRACT

An information processing apparatus includes a display control unit configured to cause a display unit to display a plurality of images, an input unit configured to input information for designating a part of the plurality of images, a setting unit configured to set a speed or a timing of deleting each image according to a degree of relativity of each image with the input information, a deletion unit configured to delete the images from the display unit according to the speed or the timing set by the setting unit.

### BACKGROUND OF THE INVENTION

1. Field of the Invention

The present invention relates to a method for searching for an image desired by a user from among a plurality of images.

2. Description of the Related Art

In recent years, digital cameras and camera-equipped mobile telephones have become widely used. In addition, capacity of a storage device such as a memory card has increased and a large-size liquid crystal display (LCD) screen has been widely used. Accordingly, a user can designate and reproduce a desired image at user's convenience.

However, it is difficult for a user to search for a desired image from among a large number of images. Accordingly, it is desirable that an imaging apparatus allow a user the ability to easily search for a desired image from among a plurality of stored images.

As an image searching method, a conventional method displays a list of reduced images (thumbnail images) and thereby allows a user to narrow down search target images according to a search condition that the user enters.

FIG. 18 schematically illustrates a narrow-down search for searching for an image desired by a user from among images displayed as a list. Referring to FIG. 18, a screen 1801 displays a plurality of images as a list. A user can enter a search condition via the screen 1801 by a text input method or a speech recognition method.

If the user enters a search condition “year 2005”, then the display screen is changed to a screen 1802. On the screen 1802, the image that does not satisfy the search condition “year 2005” is deleted from the displayed images. Further, only the images which include a description year 2005″ in metadata thereof are displayed as a list in a magnified state.

If the user further enters a search condition “May” in this state, a narrow-down search is executed and the screen is changed to a screen 1803. On the screen 1803, images that do not satisfy the search condition “May” are deleted from the displayed images. Further, on the screen 1803, the images that satisfy both search conditions “year 2005” and “May” are displayed as a list in a magnified state.

In the example illustrated in FIG. 18, if the user knows and can enter a specific appropriate search condition for extracting a desired image, then the user can easily search for the desired image from among a large number of images.

However, the user may not always know an appropriate specific search condition in searching for a desired image. For example, if the user does not remember the date of shooting of a desired image, the user may guess and enter a possibly appropriate search condition. In this case, if the desired image is not extracted by the guessed search condition, it becomes necessary for the user to press a cancel button to return to the start of the processing and to execute the search once again by using another search condition.

More specifically, in FIG. 18, the conventional method merely deletes the images that do not satisfy the search condition from the displayed images and displays the images that satisfy the search condition as a list. Accordingly, it is necessary for the user to think of another possibly appropriate search condition as he/she needed to in the failed search.

Meanwhile, if the user uses a search condition “May” in searching for a desired image and if information about image groups which are not the search targets, such as an “April” and a “June” group, is notified to the user, it may be useful for the user in executing another search for the desired image. The information about the image group which is not the search targets may include information about which image is in the group, a number of images included in the group, and the like.

Japanese Patent Application Laid-Open No. 07-319905 discusses a method for grouping images according to a search condition, such as the degree of matching with a keyword, time information, and a producer of the image, and for displaying images extracted as a result of the search.

The system discussed in Japanese Patent Application Laid-Open No. 07-319905 groups a plurality of images according to a predetermined condition and displays them. Furthermore, the system discussed in Japanese Patent Application Laid-Open No. 07-319905 merely displays information about the number of images included in each group.

Accordingly, in order to verify the images included in each group, it is necessary for a user to execute other operations.

### SUMMARY OF THE INVENTION

The present invention is directed to a technique that enables a user to effectively search for a desired image by displaying all search target images and notifying the user of processing for narrowing down to and extract an image that satisfies a search condition entered by the user.

In addition, the present invention is directed to a technique that enables a user to easily extract a desired image that does not satisfy a search condition designated by the user.

According to an aspect of the present invention, an information processing apparatus includes a display control unit configured to cause a display unit to display a plurality of images, an input unit configured to input information for designating a part of the plurality of images, a setting unit configured to set a speed or a timing of deleting each image according to a degree of relativity of each image with the input information, a deletion unit configured to delete the images from the display unit according to the speed or the timing set by the setting unit.

According to exemplary embodiments of the present invention, processing for extracting a desired image is presented to a user. Accordingly, the user can effectively extract the desired image. Furthermore, according to the exemplary embodiments of the present invention, it is enabled for a user to easily extract a desired image that does not satisfy a search condition designated by the user.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 is a block diagram illustrating an exemplary functional configuration of an information processing apparatus according to a first exemplary embodiment of the present invention.

FIG. 2 is a block diagram illustrating an exemplary hardware configuration of the information processing apparatus according to the first exemplary embodiment of the present invention.

FIG. 3 is a flow chart illustrating exemplary processing executed by the information processing apparatus according to the first exemplary embodiment of the present invention.

FIG. 4 illustrates an example of a search for an image according to a search condition.

FIG. 5 illustrates an example of a search for an image according to a search condition.

FIG. 6 illustrates an example of a search for an image according to a search condition.

FIG. 7 illustrates an example of a search for an image according to a search condition.

FIG. 8 illustrates an example of a search for an image according to a search condition.

FIG. 9 illustrates an example of a search for an image according to a search condition.

FIG. 10 illustrates an example of a list of setting values that can be set as an image shooting setting.

FIG. 11 illustrates an example of a search for a desired image without arranging images group by group.

FIG. 12 is a flow chart illustrating exemplary processing executed by the information processing apparatus according to a third exemplary embodiment of the present invention.

FIG. 13 is a flow chart illustrating exemplary processing executed by the information processing apparatus according to a fourth exemplary embodiment of the present invention.

FIGS. 14A through 14H illustrate an example of a search for a desired image if a user enters a search condition to execute an image search and further enters a different new search condition during the image search.

FIG. 15 illustrates an example of a search target image and information about the year, month, and day, which is added to each image.

FIGS. 16A through 16C illustrate an example of order (speed) set according to a search condition input to the information processing apparatus according to a fifth exemplary embodiment of the present invention.

FIGS. 17A through 17D illustrate an example of a search for a desired image by using the information processing apparatus according to the fifth exemplary embodiment of the present invention.

FIG. 18 illustrates a conventional image searching method.

### DESCRIPTION OF THE EMBODIMENTS

Various exemplary embodiments, features, and aspects of the invention will be described in detail below with reference to the drawings.

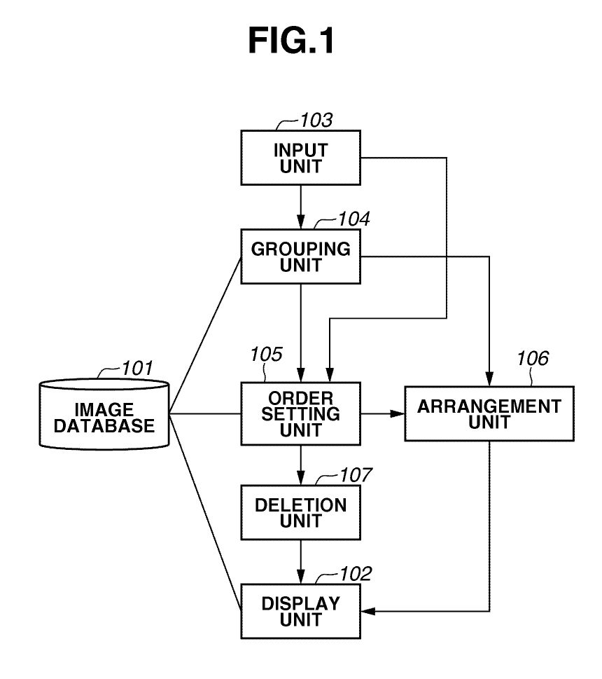

A first exemplary embodiment of the present invention will now be described below. FIG. 1 is a block diagram illustrating an exemplary configuration of an information processing apparatus according to the present exemplary embodiment. Referring to FIG. 1, the information processing apparatus includes an image database 101, a display unit 102, an input unit 103, a grouping unit 104, an order setting unit 105, an arrangement unit 106, and a deletion unit 107.

The image database 101 stores images. The image database 101 includes a publicly known recording medium, such as a memory or a hard disk.

The display unit 102 displays the images stored on the image database 101 as a list. The display unit 102 includes a liquid crystal display (LCD) and an organic electroluminescence (EL) display.

A user can operate the input unit 103 to input a search condition for searching for a desired image. The input unit 103 includes a publicly known input device, such as a mouse, a keyboard, a switch, or a microphone.

The grouping unit 104 classifies the plurality of images displayed on the display unit 102 as a list into two or more groups.

The order setting unit 105 sets an order for deleting at least a part of the plurality of images displayed on the display unit 102 according to information including the search condition input via the input unit 103.

The arrangement unit 106 arranges the images included in each group classified by the grouping unit 104 and displayed on the display unit 102.

The deletion unit 107 deletes, from the images displayed on the display unit 102, an image that does not satisfy the search condition according to the timing or speed determined based on the order set by the order setting unit 105.

The grouping unit 104, the order setting unit 105, the arrangement unit 106, and the deletion unit 107 are program modules for executing display control. Each of the above-described program modules is implemented by a central processing unit (CPU) of the information processing apparatus by loading and executing a program from a read-only memory (ROM) on a random access memory (RAM). More specifically, the grouping unit 104, the order setting unit 105, the arrangement unit 106, and the deletion unit 107 include the CPU, the ROM, and the RAM.

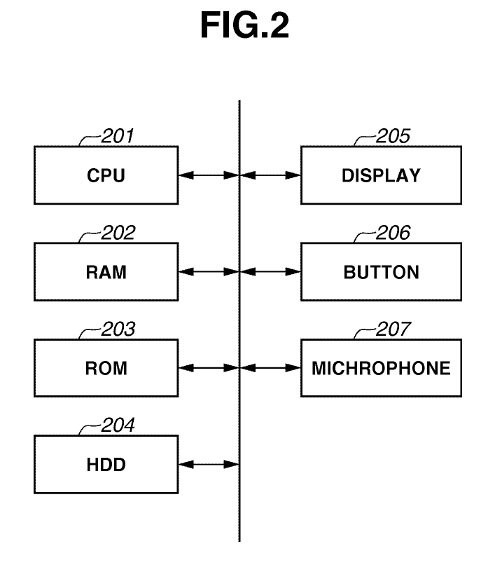

FIG. 2 is a block diagram illustrating an exemplary hardware configuration of the information processing apparatus according to the first exemplary embodiment of the present invention. Referring to FIG. 2, the information processing apparatus includes a CPU 201, a RAM 202, a ROM 203, a hard disk drive (HDD) 204, a display 205, a button 206, and a microphone 207.

The CPU 201 controls the execution of the functions of the information processing apparatus and the operation of the entire information processing apparatus. The RAM 202 functions as a main memory for the CPU 201. The ROM 203 stores a program and fixed data. The HDD 204 stores the image database 101. A program that implements the image searching function can be stored on either the ROM 203 or the HDD 204.

The display 205 implements the function of the display unit 102. The user can press the button 206 to enter text data of a search condition. The button 206 implements the function of the input unit 103. The microphone 207 is used by the user to input a search condition as audio data. The microphone 207 also implements the function of the input unit 103.

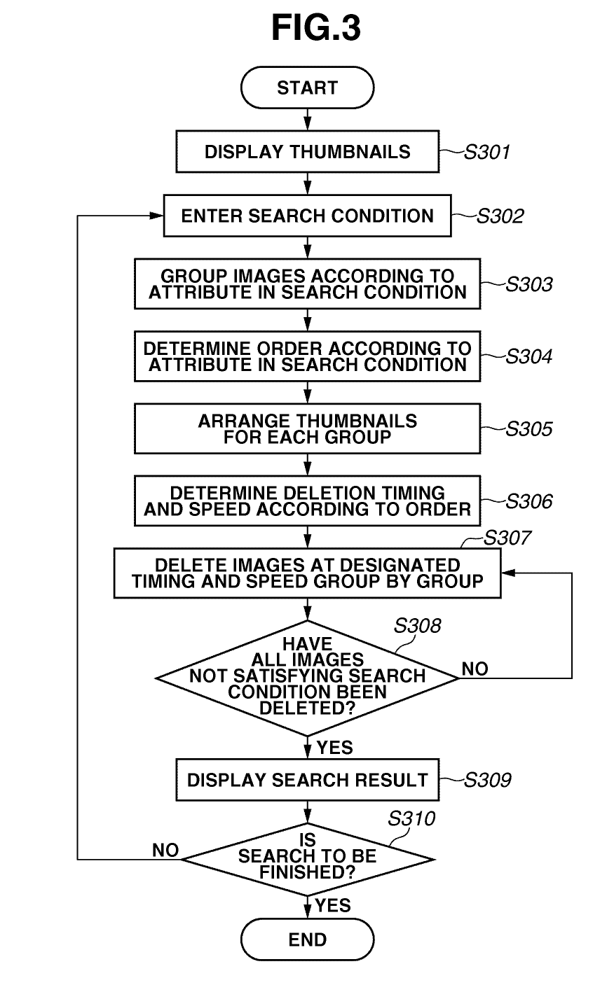

Now, an exemplary flow of processing for searching for a desired image will be described in detail below. FIG. 3 is a flow chart illustrating exemplary processing executed by the information processing apparatus according to the first exemplary embodiment.

In step S301, the display unit 102 displays thumbnails of search target images as a list.

In step S302, the CPU 201 acquires information corresponding to the search condition input by the user via the input unit 103. In the present exemplary embodiment, the “search condition” refers to information about shooting year, date, day, or time information, such as “year 2005”, “May”, “Sunday”, or “evening”. In addition, the “search condition” includes image shooting setting information, such as “macroscopic shooting mode” or “distant landscape shooting mode”. Further, the search condition is information which is input by the user via a keyboard as text data or via the microphone 207 as audio data.

In step S303, the grouping unit 104 classifies images into groups according to a unit of numerical values included in the search condition. For example, if the search condition is “year 2005”, the grouping unit 104 groups the images based on a word “year” in the unit of a year. Similarly, if the search condition is “May”, the grouping unit 104 groups the images in the unit of a month.

Furthermore, if the search condition “macroscopic shooting mode”, which is a word indicating an image shooting setting, is entered by the user, the grouping unit 104 groups the images according to the image shooting setting, such as “macroscopic shooting mode”, “distant landscape shooting mode”, or “normal shooting mode”.

In step S304, the order setting unit 105 sets an order to each group according to the acquired search condition and information about each group. In the present exemplary embodiment, for the “order”, an ascending order or a descending order of the information input as the search condition can be used. In addition, it is also useful if the order is set according to the descending chronological difference between each group and the information input as a search condition. Furthermore, it is also useful if the order is set according to the ascending semantic order of the degree of similarity between the groups and the input information. Furthermore, the order can be set on each image instead of setting the order on each group.

In step S305, the arrangement unit 106 arranges the plurality of images so that they are displayed on the display unit 102 group by group. The “images” displayed on the display unit 102 at this timing refers to a plurality of thumbnail images, which is displayed as a list. For the order of arranging the images group by group, either the order set by the order setting unit 105 or the order of reading the images can be used.

In step S306, the deletion unit 107 sets timing and a speed of deleting the images included in a group that does not satisfy the search condition according to the order set by the order setting unit 105. The image deletion timing is stored as information indicating delay time from the time when the deletion of the image starts. The image deletion speed refers to a speed of deleting the images included in the group failing the search condition from the displayed images by utilizing a publicly known animation effect, such as “fade out”, “wipe out”, “zoom out”, and “dissolve” effects.

In step S307, the deletion unit 107 deletes the images included in the group that does not satisfy the search condition group by group according to the above-described timing and speed. In step S308, the CPU 201 determines whether all the images included in the groups that do not satisfy the search condition have been completely deleted. If it is determined that any image included in the group failing the search condition remains undeleted (NO in step S308), then the processing returns to step S307. The processing in step S307 is repeated until it is determined that all the groups that do not satisfy the search condition have been completely deleted.

If the deletion speed is set so that the deletion unit 107 deletes quickly the images that do not satisfy the search condition in an ascending order, images whose degree of relativity with the search condition is low can be quickly deleted from the displayed images while those with a high degree of relativity with the search condition can be properly deleted.

In the above-described manner, the present exemplary embodiment can allow the user to easily verify whether the images that do not directly match the search condition but include a parameter value similar to the search condition include an image desired by the user.

In step S309, the CPU 201 displays the images included in the group that satisfies the search condition on the display unit 102 as a search result.

In step S310, the CPU 201 prompts the user to determine whether to execute a further search. More specifically, the CPU 201 displays a dialog for prompting the user to input an instruction on whether to execute a further search by a narrowing search condition.

If the user inputs an instruction for executing a narrowed search (No in step S310), then the processing returns to step S302 and repeats the processing in step S302 and beyond. On the other hand, if the user inputs an instruction for ending the search (YES in step S310), the above-described series of processing ends.

Now, the display on the display unit 102 in serially deleting the images that do not satisfy the search condition will be described in detail below.

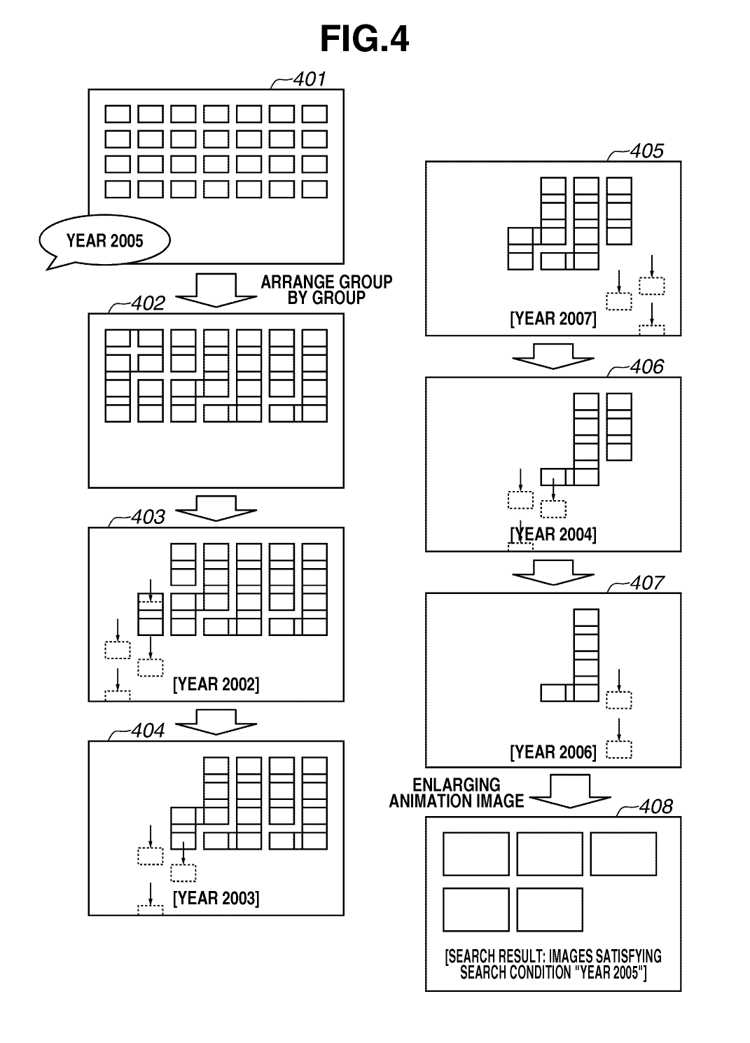

FIG. 4 illustrates an example of a screen displayed during the search for a desired image when the user inputs a search condition “year 2005”.

Referring to FIG. 4, screens 401 through 408 are serially displayed on the display unit 102 as the processing progresses. The screen displayed on the display unit 102 is changed from the screen 401 to the screen 402, then to the screen 403. After that, the screen is changed in the ascending reference numeral order.

In the example illustrated in FIG. 4, the display unit 102 displays a list of a plurality of search target images as indicated by the screen 401. In the present exemplary embodiment, it is supposed that twenty-eight images, which are taken and stored during a time period from the year 2002 to the year 2007, are displayed on the display unit 102.

If the user inputs audio information “year 2005” via the microphone 207 as the search condition, the arrangement unit 106 classifies the plurality of displayed images into a plurality of groups, each of which corresponding to a specific year, according to the information “year” included in the search condition.

In the present exemplary embodiment, in classifying and grouping the images, the arrangement unit 106 refers to information about the year of generation of the image based on exchangeable image file format (Exif) information added to each image. Further, the arrangement unit 106 groups the images according to the acquired information about the year of generating the images.

Now, processing for classifying and grouping images will be described in detail below. At first, the order setting unit 105 sets an order “year 2002, year 2003, year 2007, year 2004, and year 2006” according to the descending chronological difference from the year 2005, which is the input search condition.

Then, the grouping unit 106 groups a plurality of images displayed on the screen 401 in the unit of a year. In the present exemplary embodiment, it is supposed that six images are included in the year 2002 group, four in the year 2003 group, five in the year 2007 group, five in the year 2004 group, three in the year 2006 group, and five in the year 2005 group.

In the present exemplary embodiment, a plurality of images, which is classified in each year group, is displayed on the display unit 102 as indicated on the screen 402. On the screen 402, each group is surrounded by a thick-line frame to clearly indicate that the plurality of images is classified group by group.

The screens 403 through 407 are displayed at the following timing. More specifically, the screens 403 through 407 are displayed on the display unit 102 if processing for deleting the images that do not satisfy the search condition is executed.

In the present exemplary embodiment, to “delete an image” means deletion of an image from the display unit 102 by using a publicly known animation effect, namely, a “fade out” method, for example.

The timing of deleting an image is based on the timing set by the deletion unit 107 on each group. In the present exemplary embodiment, the above-described timing is previously set and has a constant time interval (of two seconds, for example). The deletion unit 107 deletes the images included in one group at a previously set constant time interval.

For the above-described timing, it is useful if the timing for deleting the group whose difference from the search condition is large is set at an early timing while the timing for deleting the group whose difference from the search condition is small is set at a late timing.

More specifically, in the present exemplary embodiment, the images included in the year 2002 group are deleted at the timing of the start of the deletion processing (hereinafter simply referred to as the “deletion start timing”) and those included in the year 2003 group are deleted at the timing one second after the deletion start timing.

Then, the deletion unit 107 deletes the images included in the year 2007 group at the timing three seconds after the deletion start timing. Moreover, the deletion unit 107 deletes the images included in the year 2004 group at the timing six seconds after the deletion start timing. Furthermore, the deletion unit 107 deletes the images included in the year 2006 group at the timing ten seconds after the deletion start timing.

It is also useful if the above-described timing is determined according to a number of images included in each group.

It is also useful if a length of time until the images are deleted from the display unit 102 is set according to the order set by the order setting unit 105 without changing the deletion start timing. With the above-described configuration, the images included in the “year 2002” group are deleted from the display unit 102 in four seconds from the deletion start timing. Further, the images included in the “year 2003” group are deleted from the display unit 102 in six seconds from the deletion start timing.

In addition, the images included in the “year 2007” group are deleted from the display unit 102 in nine seconds from the start of the deletion. Moreover, the images included in the “year 2004” group are deleted from the display unit 102 in thirteen seconds from the start of the deletion. The images included in the “year 2006” group are deleted from the display unit 102 in sixteen seconds from the start of the deletion.

The screen 403 displays a state in which the six images included in the “year 2002” group are deleted from the display unit 102. Similarly, the screen 404 displays a state in which the images included in the “year 2003” group are deleted. The screen 405 displays a state in which the images included in the “year 2007” group are deleted. Further, the screen 406 displays a state in which the images included in the “year 2004” group are deleted. The screen 407 displays a state in which the images included in the “year 2006” group are deleted.

When images are deleted group by group, the display unit 102 may display information corresponding to each group. Further, when images are deleted group by group, the images included in each image deletion target group may be magnified by a magnification ratio of 1.2 or around to notify the user that the image is to be deleted before actually deleting the same from the display unit 102. With the above-described configuration, the present exemplary embodiment can allow the user to easily verify to which group the deletion processing is executed.

After the processing for deleting the images from the screen, images that satisfy the search condition (five images included in the “year 2005” group) are displayed on the display unit 102 as displayed on the screen 408.

When the images that satisfy the search condition are displayed, it is also useful if the search condition satisfying images are magnified larger than the plurality of search target images displayed as a list. With this configuration, the present exemplary embodiment can effectively utilize the display area of the display unit 102.

Now, a method for searching for an image if the user has input information other than a specific year as the search condition will be described in detail below.

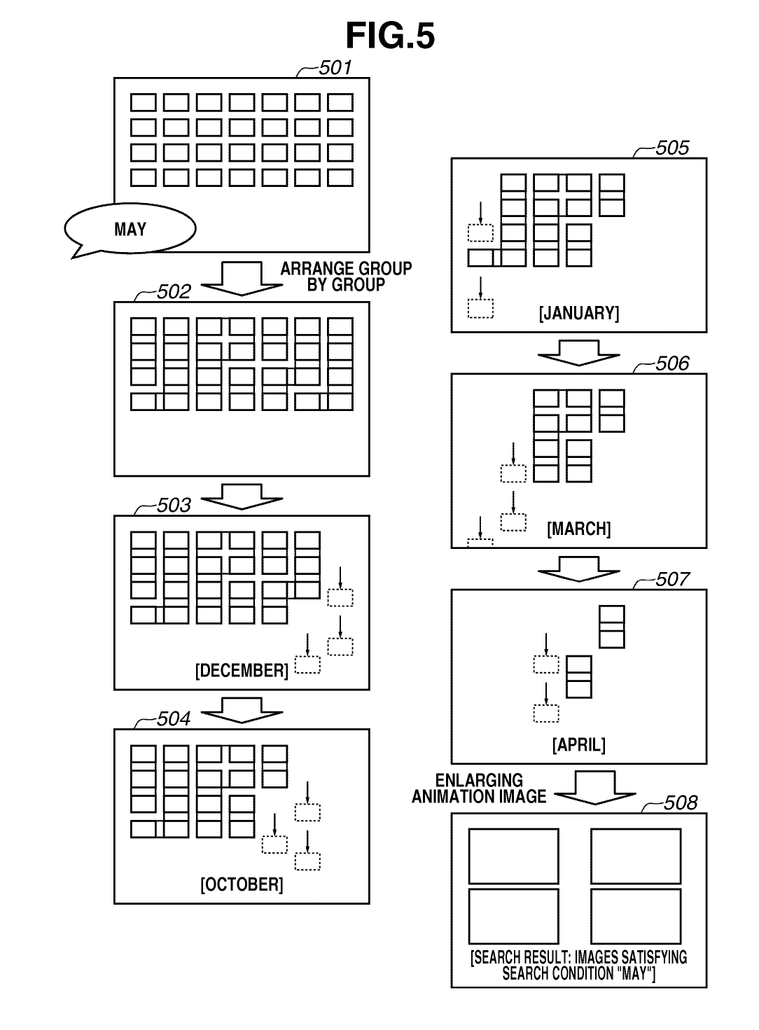

FIG. 5 illustrates an example of a search for an image according to a search condition “May”. If the user inputs a word “May” as audio data for a search condition, then the grouping unit 104 classifies the images into groups of the unit of a month according to the unitary search condition “month”.

Then, the arrangement unit 106 arranges a plurality of search target images into monthly groups and displays the grouped images.

In the present exemplary embodiment, it is supposed that a “December” group includes five images, an “October” group includes five images, and a “January” group includes three images. Further, it is supposed that a “March” group includes five images, an “April” group includes six images, and a “May” group includes four images.

In the present exemplary embodiment, images included in each group are deleted group by group chronologically as the screen shifts from a screen 503 to a screen 507.

The longer the time length of the month of a group is from May, which is the search condition, the sooner the images included therein are faded out. When the image deletion processing starts, four images included in the “May” group are finally displayed on the display unit 102, as indicated with the screen 507 in FIG. 5.

In addition, when the image deletion processing ends, the four images included in the “May” group are displayed on a screen 508 in a magnified state.

Suppose, when the screen 506 is currently displayed on the display unit 102, that the user has found that six images included in the “April” group are desired images. In this case, the user can input an instruction signal for suspending the image deletion processing via the button 206.

It is also useful if the plurality of images displayed on the display unit 102 are magnified when the image deletion processing is suspended. More specifically, if the image deletion processing is suspended when the screen 506 is displayed on the display unit 102, then six images included in the “April” group and four images included in the “May” group are displayed on the display unit 102 in a magnified state. With the above-described configuration, the present exemplary embodiment can allow the user to easily find a desired image that does not satisfy the search condition. In addition, the present exemplary embodiment can allow the user to extract the desired image as a search result without having to enter the search condition again.

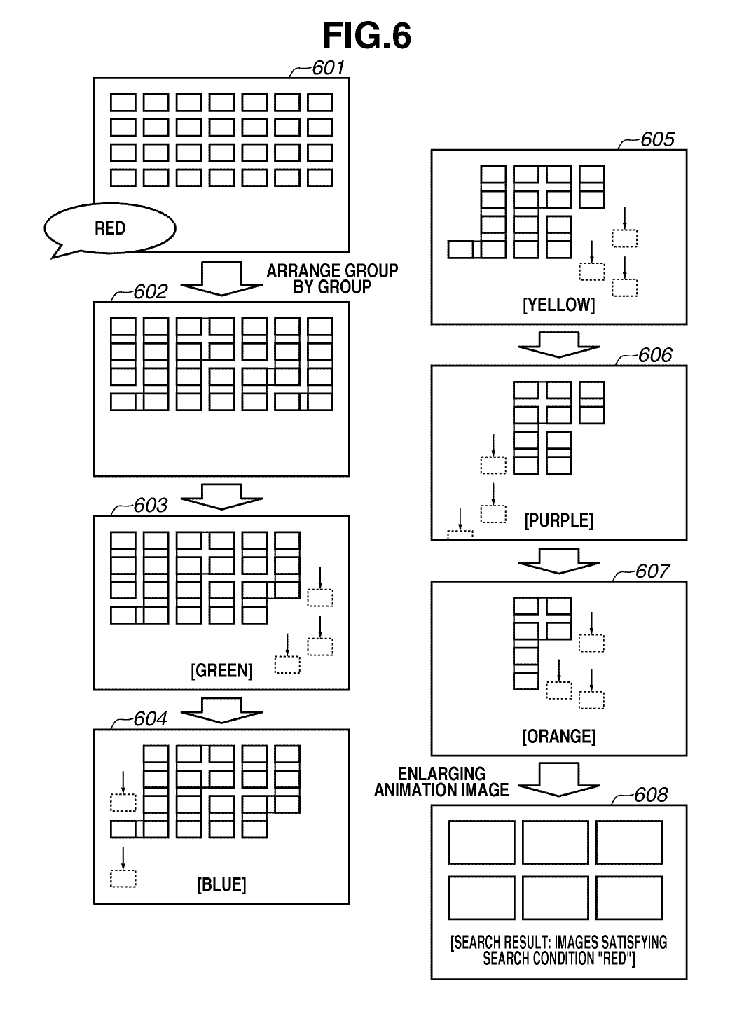

FIG. 6 illustrates a search for an image according to a search condition “red”. If the user inputs a search condition “red”, then the grouping unit 104 determines that information related to a color has been input, and classifies the plurality of search target images into groups according to a color. In grouping the plurality of search target images according to a color, the grouping unit 104 previously classifies a color space such as red (R), green (G), and blue (B) color space.

Further, the grouping unit 104 extracts a representative color from each image by using a publicly known image analysis method. In the present exemplary embodiment, a publicly known image analysis method refers to a method for analyzing an average tint or a color dominantly used in each image.

Then, in the present exemplary embodiment, the grouping unit 104 classifies the plurality of search target images into six groups including “red”, “orange”, “yellow”, “green”, “blue”, and “purple” groups according to the representative color of each extracted image. A screen 602 (FIG. 6) illustrates a state in which the images are divided into a plurality of color groups and the images included in the color groups are arranged and displayed.

In addition, the deletion unit 107 serially deletes the images starting from those included in the group whose color distance from the search condition “red” in the color space is the greatest. More specifically, the images included in the groups “purple” and “orange”, whose tint is close to the tint of the search condition color “red” are deleted at a timing later than the timing for deleting the images included in each of the “yellow”, “green”, and “blue” groups.

Screens 603 through 607 illustrated in FIG. 6 each indicate information about the group whose images are currently deleted. In the present exemplary embodiment, the “information about the group whose images are currently deleted” refers to, for example, a text “green”, which is displayed on the display unit 102 while deleting the images included in the “green” group on the screen 603.

It is also useful if the color corresponding to the color of the groups whose images are currently deleted is displayed on the background of the plurality of images on the display unit 102. More specifically, in this case, if the images included in the “green” group are currently deleted, the color of the background is green. Similarly, if the images included in the “blue” group are currently deleted, then the color of the background is blue. Furthermore, it is also useful if the background color is chronologically changed as the time passes. With the above-described configuration, the present exemplary embodiment can allow the user to extract the image that does not satisfy the search condition but includes the desired tint as a search result.

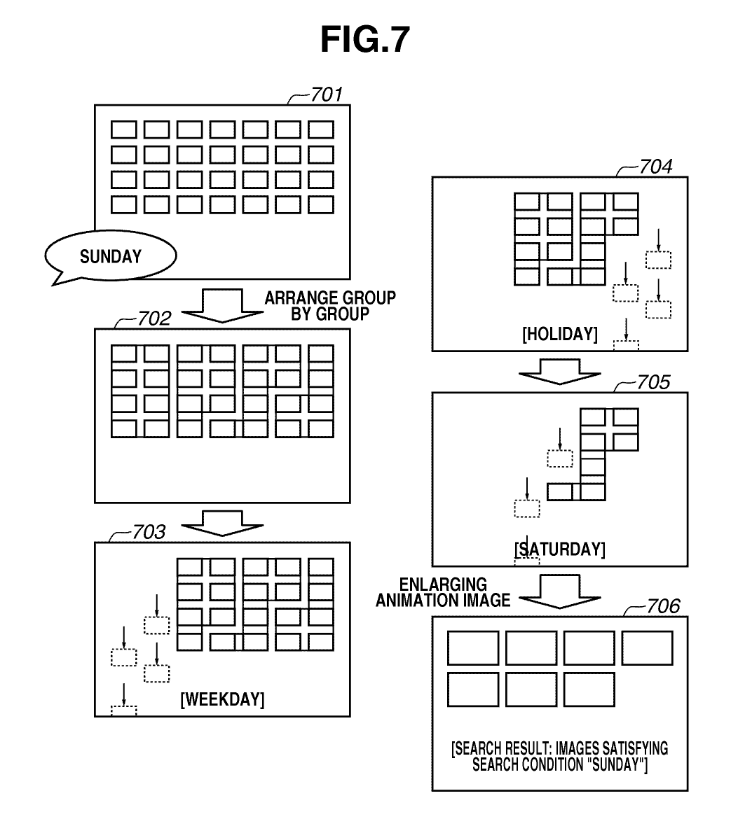

FIG. 7 illustrates an example of a search for an image according to a search condition “Sunday”. In the example illustrated in FIG. 7, the images are grouped in an unevenly determined unit.

If the user inputs information “Sunday” as the search condition as displayed on a screen 701, then the grouping unit 104 groups the plurality of search target images in the unit (granularity) “day of the week”.

In the present exemplary embodiment, in grouping the plurality of search target images according to the search condition “day of the week”, the grouping unit 104 groups the search target images into a plurality of groups including “Sunday”, “Saturday”, “holiday”, and “weekday” groups, instead of grouping the same into seven day groups including “Sunday”, “Monday”, “Tuesday”, “Wednesday”, “Thursday”, “Friday”, and “Saturday” groups. In other words, some groups include a plurality of days while the others include only one day group.

The above-described day grouping method is useful for a user who more frequently performs shooting using a digital camera on holidays than on weekdays. Because it is likely that a number of images to be included in each of the “Saturday”, “Sunday”, and “holiday” groups, on which days most users may take the day off, is large while the number of those included in the “weekday” group is likely to be small. With the above-described configuration, the present exemplary embodiment can effectively prevent a great difference in the numbers of the images included in the above-described groups from arising.

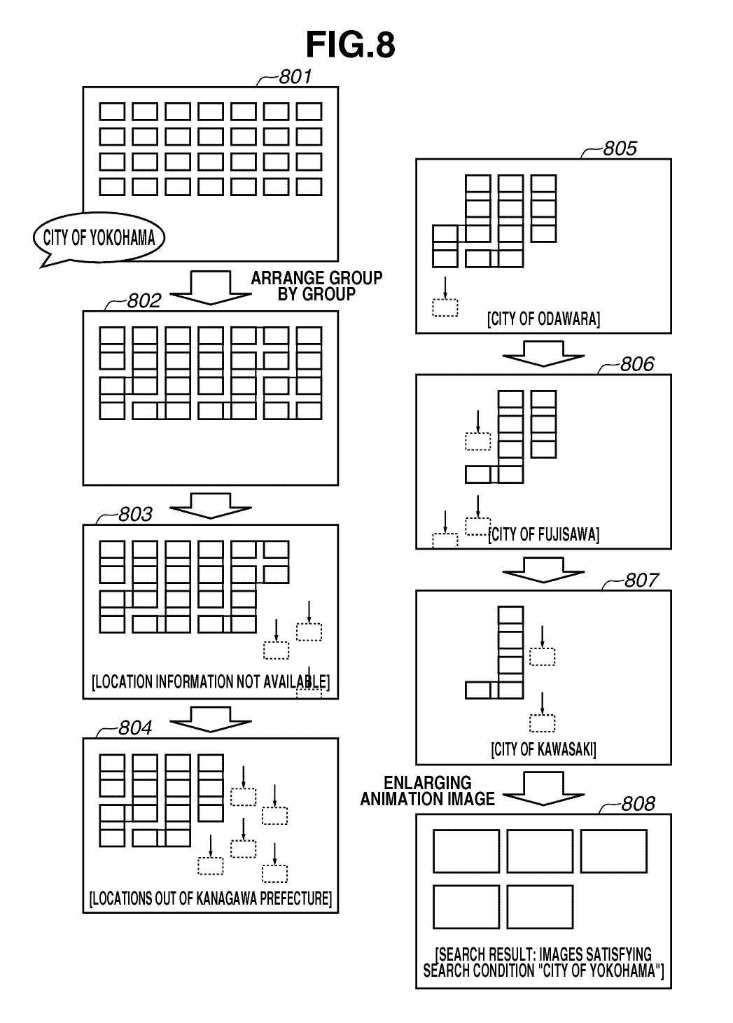

FIG. 8 illustrates an example of a search for an image according to a search condition “City of Yokohama”. If the user inputs the search condition “City of Yokohama”, then the grouping unit 104 groups the plurality of search target images according to positional information such as global positioning system (GPS) information provided to each image in an Exif format.

The grouping unit 104 converts the GPS information that has been added to each image into address information. When the GPS information is converted into the address information, for example, map information database is used as reference data. In the present exemplary embodiment, the map information database is previously stored on the HDD 204.

Referring to FIG. 8, a screen 801 illustrates a state in which the information “City of Yokohama” has been acquired via the input unit 103. If the search condition “City of Yokohama” is acquired, the grouping unit 104 extracts information “city” as the unit for the search condition.

Then, the grouping unit 104 divides the plurality of search target images into a plurality of groups each corresponding to a city.

In the present exemplary embodiment, images associated with a city of Kanagawa Prefecture, to which the City of Yokohama (the search condition city) belongs, are grouped in the unit of a city group. The images associated with a city of a prefecture other than Kanagawa Prefecture are grouped in the unit of a prefecture. However, it is also useful if all the images associated with prefectures other than Kanagawa Prefecture are grouped into one group.

In addition, the order setting unit 105 sets an order to each group so that the groups of images are serially deleted in the descending order of geographical distance of the city or prefecture of a group from the “City of Yokohama” as the search condition city.

Then, the arrangement unit 106 arranges the plurality of search target images on the display unit 102 according to the order set by the order setting unit 105.

Then, the deletion unit 107 deletes the images included in each group from the display unit 102 group by group according to the order set by the order setting unit 105.

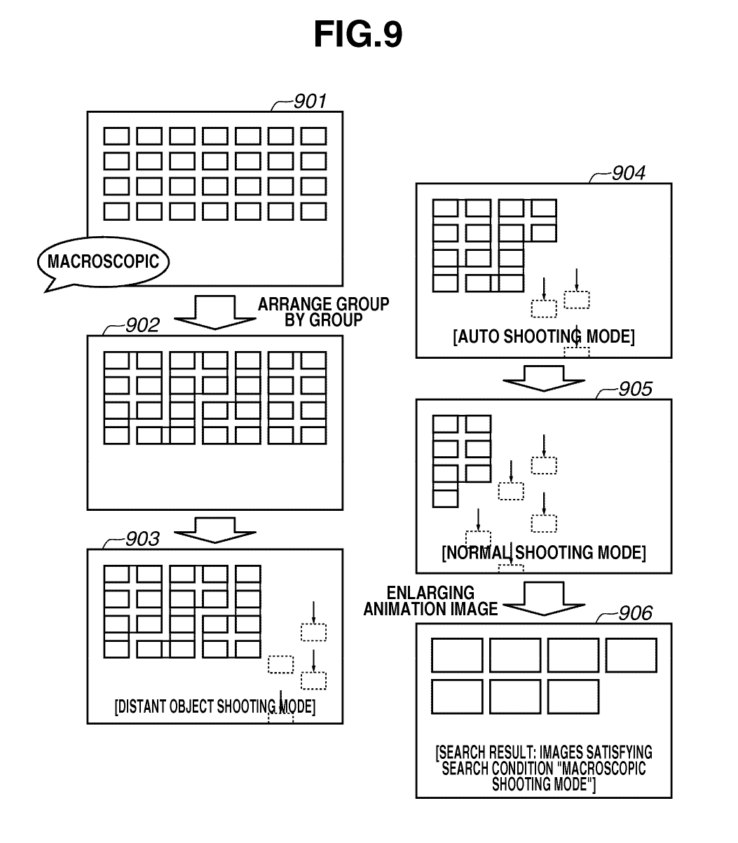

FIG. 9 illustrates an example of a search for an image according to a search condition “macroscopic shooting mode”. If the user inputs the search condition “macroscopic shooting mode”, then the grouping unit 104 determines that information about image shooting setting has been input and executes processing for grouping the plurality of search target images according in the unit of image shooting setting.

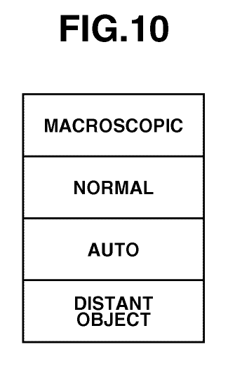

FIG. 10 illustrates an example of a list of setting values that can be set as an image shooting setting. In the present exemplary embodiment, it is supposed that four kinds of setting values can be used, namely, “macroscopic shooting mode”, “normal shooting mode”, “auto shooting mode”, and “distant landscape shooting mode”. Each setting value corresponds to a setting for such as shooting from a close distance or from a far distance, which is set in shooting an image using a digital camera.

In the present exemplary embodiment, the grouping unit 104 groups the plurality of search target images into four image groups including a group including images provided with setting information “macroscopic shooting mode”, a group including images provided with setting information “normal shooting mode”, a group including images provided with setting information “auto shooting mode”, and a group including images provided with setting information “distant landscape shooting mode”.

Then, the order setting unit 105 sets an order in the ascending or descending order of the images included in the list illustrated in FIG. 10.

Then, the arrangement unit 106 arranges and displays the plurality of search target images on the display unit 102 according to the order set by the order setting unit 105.

Then, the deletion unit 107 deletes the images included in each group from the display unit 102 group by group according to the order set by the order setting unit 105.

In the above-described manner, the present exemplary embodiment previously stores a list of setting values. Accordingly, the present exemplary embodiment can allow the user to search for a desired image according to an arbitrary search condition, such as information about the image shooting setting.

Now, a second exemplary embodiment of the present invention is described below. In the above-described first exemplary embodiment, a plurality of search target images is displayed on the display unit 102 in groups by the arrangement unit 106 as displayed on the screen 402 illustrated in FIG. 4. However, the plurality of search target images are not always necessary to be classified into groups. In other words, it is not always necessary to provide the arrangement unit 106 in the present exemplary embodiment.

In the second exemplary embodiment, the information processing apparatus illustrated in FIG. 1 does not include the arrangement unit 106. Further, the information processing apparatus according to the present exemplary embodiment skips the processing in step S305 in FIG. 3.

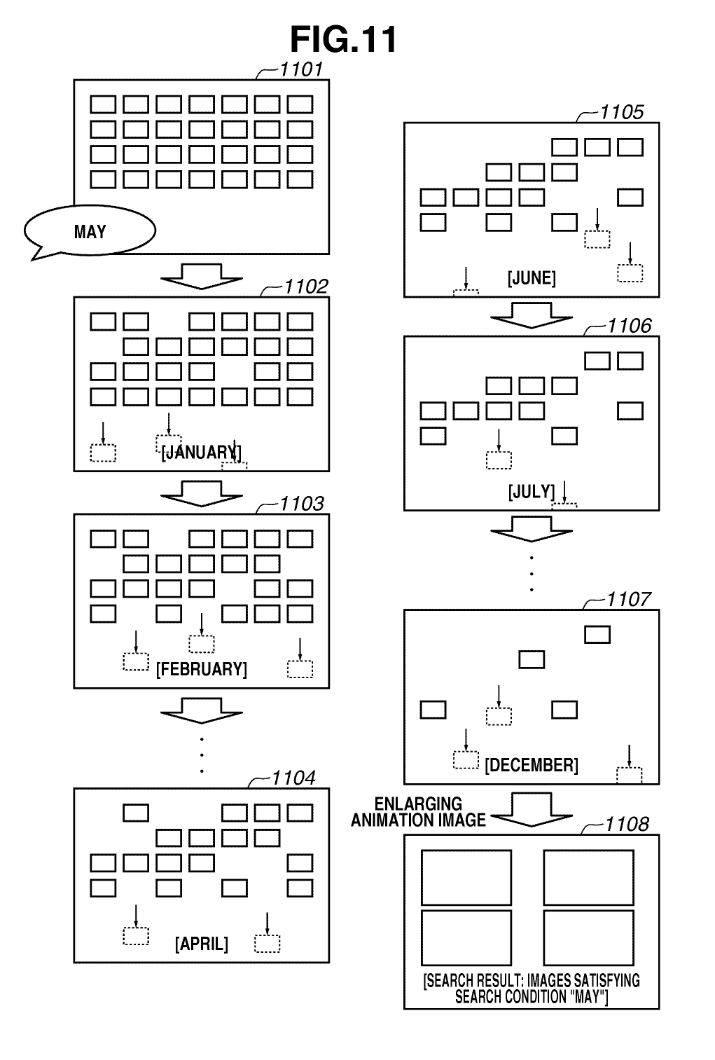

FIG. 11 illustrates an example of a search for a desired image without arranging the images group by group. As illustrated in a screen 1101, if the user inputs a word “May” as a search condition as in the first exemplary embodiment, then the grouping unit 104 groups the plurality of search target images in the unit of a month according to the unitary search condition “month”.

In addition, the order setting unit 105 determines an order of each group. The present exemplary embodiment does not execute processing for displaying the plurality of search target images group by group on the display unit 102. In other words, even if groups are set, the screen displayed on the display unit 102 does not change in the present exemplary embodiment.

Then, as displayed on screens 1102 through 1107, the deletion unit 107 deletes the images included in the group that does not satisfy the search condition from the display unit 102 in the order set to each group by the order setting unit 105.

In the above-described manner, the present exemplary embodiment stores the order of arranging of the images in the list of search target images. With the above-described configuration, the present exemplary embodiment can allow the user to easily find a desired image that does not satisfy the search condition.

Now, a third exemplary embodiment of the present invention will be described in detail below. If the user inputs a new search condition during image deletion processing, then the present exemplary embodiment executes processing for searching for an image according to the newly input search condition. The functional components of the information processing apparatus according to the present exemplary embodiment is similar to those of the information processing apparatus of the first exemplary embodiment described above with reference to FIG. 1. Accordingly, the description thereof will not be repeated here.

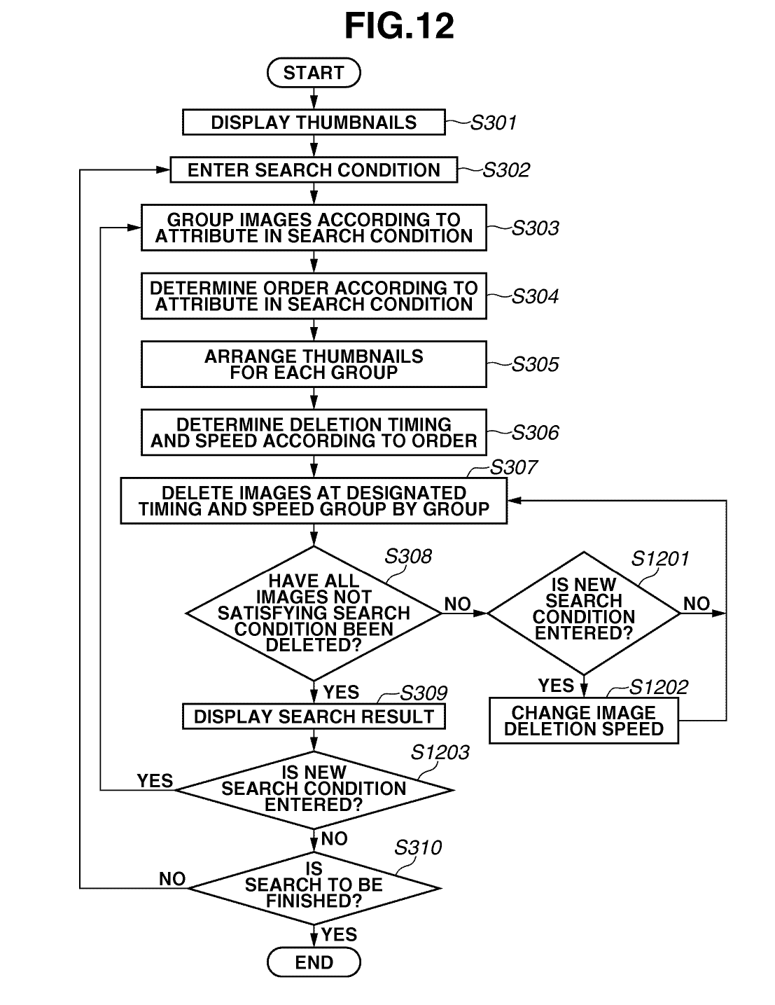

FIG. 12 is a flow chart illustrating exemplary processing executed by the information processing apparatus according to the third exemplary embodiment. In the present exemplary embodiment, the processing similar to that described above with reference to FIG. 3 are provided with the same reference numerals and symbols not to repeat the description thereof here.

Referring to FIG. 12, in step S308, if it is determined that all the images that do not satisfy the search condition have not been deleted from the display unit 102 (NO in step S308), then the processing advances to step S1201.

In step S1201, the CPU 201 determines whether a new search condition has been input via the input unit 103. If it is determined that the new search condition has been input (YES in step S1201), then the processing advances to step S1202. On the other hand, if it is determined that no new search condition has been input (NO in step S1201), then the processing advances to step S307.

In step S1202, the CPU 201 increases the speed of deleting the images from the display unit 102. By executing the processing in step S1202, the time taken for completely deleting all the images not satisfying the search condition from the display unit 102 can be reduced.

In step S309, the CPU 201 displays an image that satisfies the search condition input earlier on the display unit 102 as a search result.

In step S1203, the CPU 201 determines whether a new search condition has been input. If it is determined that the new search condition has been input (YES in step S1203), then the processing advances to step S303. The images to be subjected to the processing in step S303 are the plurality of images included in the search result acquired in step S309.

On the other hand, if it is determined that no new search condition has been input (NO in step S1203), then the processing advances to step S310.

Suppose, in the example illustrated in FIG. 3, that the user has input information “year 2005” as the search condition and if the user further inputs information “May” as a new search condition during the image deletion processing executed in steps S303 through S307 (particularly in step S305, for example). In this case, after inputting the information “May”, in steps S306 and S307, the CPU 201 increases the speed of deleting images to a level higher than the deletion speed set in step S307. Further, the deletion unit 107 deletes the images from the display unit 102 at the increased image deletion speed.

In step S308, the display unit 102 displays a result of the search executed according to the search condition “year 2005”. Then, the CPU 201 executes the processing in step S303 and beyond on the image included in the search result according to the search condition “May”. With the above-described configuration, the present exemplary embodiment can allow the user to effectively narrow down to the desired image.

Now, a fourth exemplary embodiment of the present invention will be described in detail below. Suppose that the user has input a new search condition while executing image deletion processing and that the image deletion speed has been changed or that the image deletion processing itself has been suspended. In this case, the present exemplary embodiment executes processing for displaying a result of the suspended deletion processing. The functional components of the information processing apparatus according to the present exemplary embodiment is similar to those of the information processing apparatus of the first exemplary embodiment described above with reference to FIG. 1. Accordingly, the description thereof will not be repeated here.

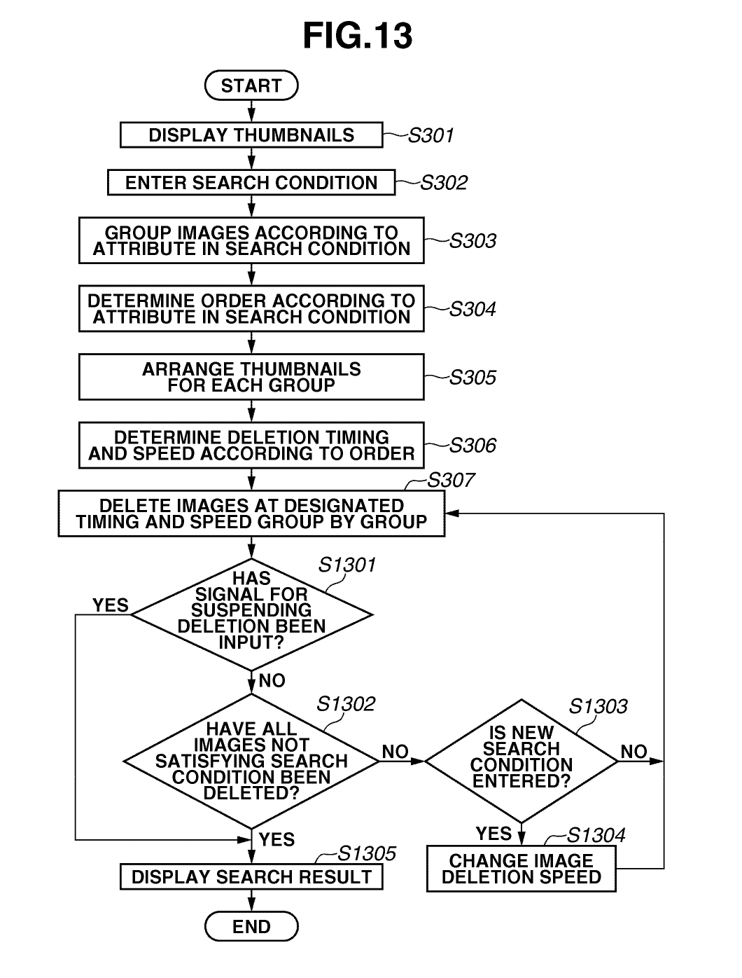

FIG. 13 is a flow chart illustrating exemplary processing executed by the information processing apparatus according to the fourth exemplary embodiment. In the present exemplary embodiment, the processing similar to that described above with reference to FIG. 3 are provided with the same reference numerals and symbols not to repeat the description thereof here.

In step S307, deletion processing is executed and the processing advances to step S1301. In step S1301, the CPU 201 determines whether the user has input a signal for suspending the image deletion processing via the input unit 103.

If it is determined that the signal for suspending the image deletion processing is input (YES in step S1301), then the processing advances to step S1305. On the other hand, if it is determined that the signal for suspending the image deletion processing is not input (NO in step S1301), then the processing advances to step S1302.

In step S1302, the CPU 201 determines whether all the images included in the groups that do not satisfy the search condition have been completely deleted from the display unit 102. If it is determined that all the images included in the groups that do not satisfy the search condition have been completely deleted (YES in step S1302), then the processing advances to step S1305. On the other hand, if it is determined that all the images included in the groups that do not satisfy the search condition have not been completely deleted (NO in step S1302), then the processing advances to step S1303.

In step S1305, the display unit 102 displays the images that have not been deleted therefrom in a magnified state as a search result.

In step S1303, the CPU 201 determines whether a new search condition has been input via the input unit 103. If it is determined that the new search condition has been input (YES in step S1303), then the processing advances to step S1304. On the other hand, if it is determined that no new search condition has been input (NO in step S1303), then the processing advances to step S307.

In step S1304, the CPU 201 sets an image deletion speed so that the time to be taken until the images satisfying the newly input search condition are deleted from the display unit 102.

After the processing in step S1304, the CPU 201 executes the processing in step S307 by using the deletion unit 107 according to the newly set deletion speed.

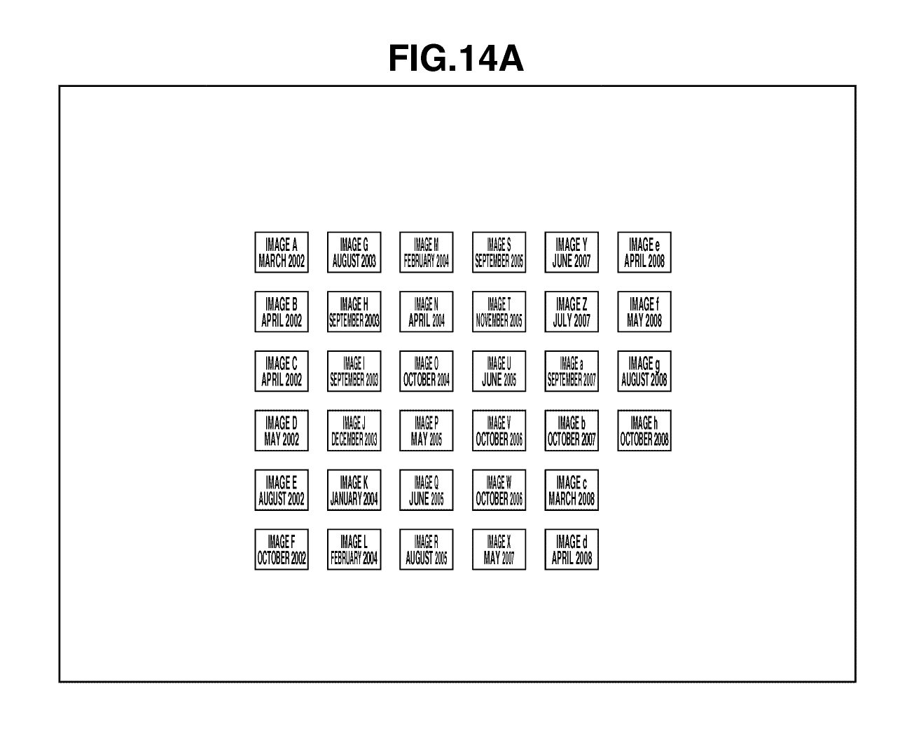

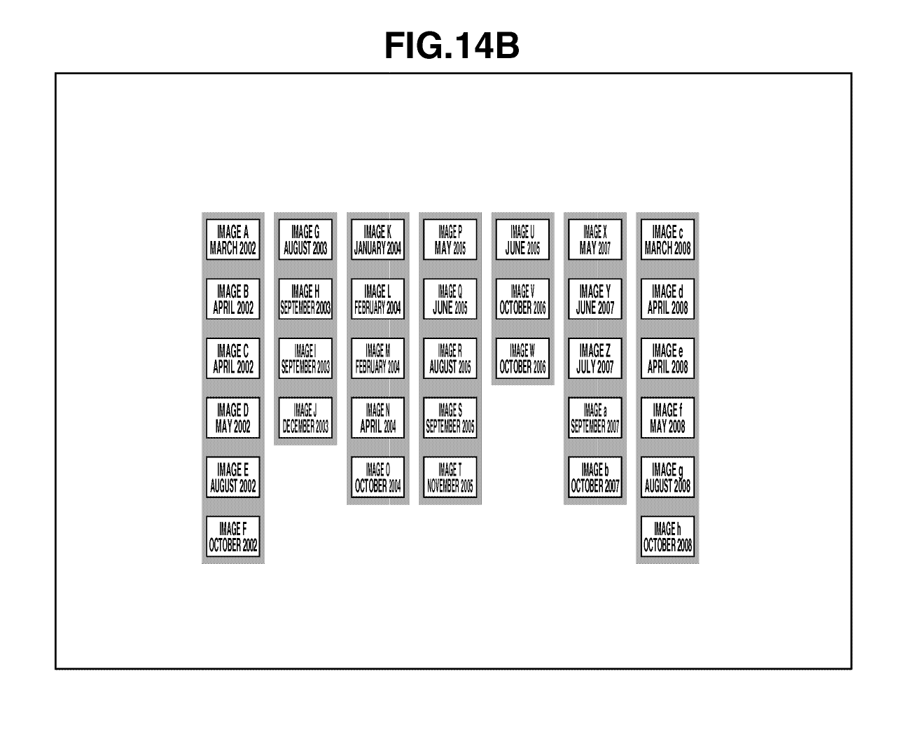

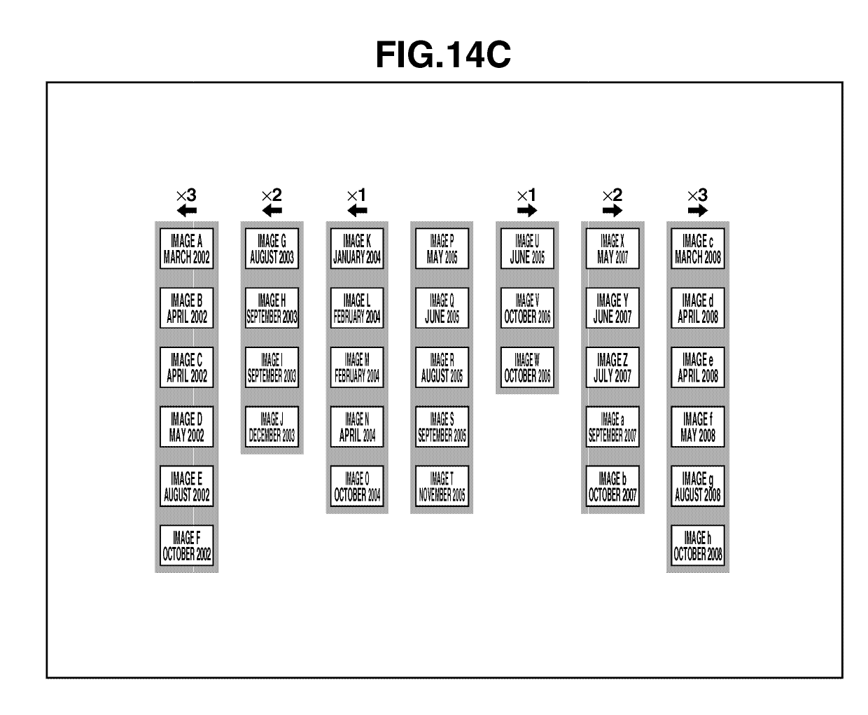

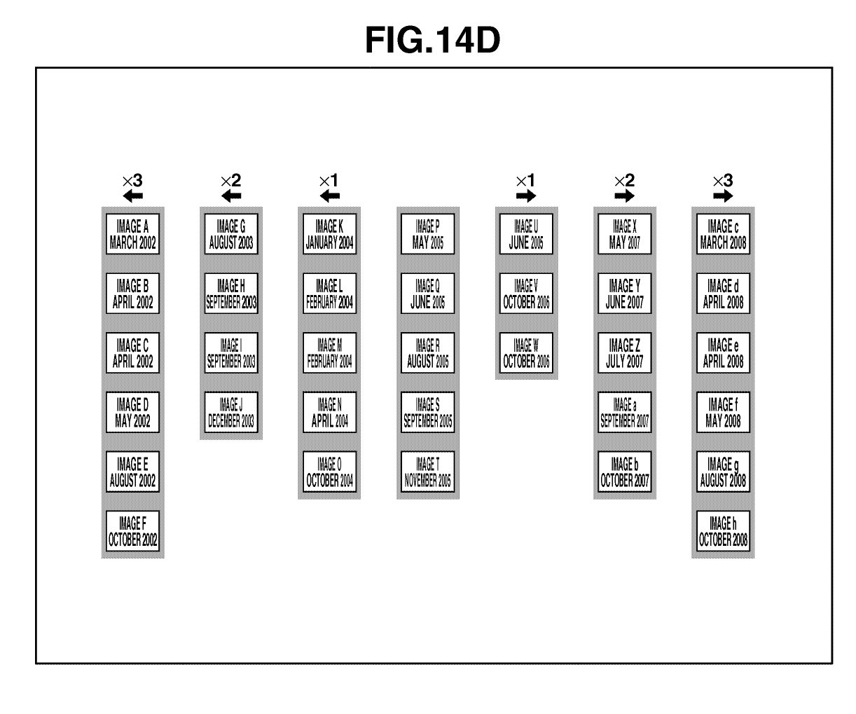

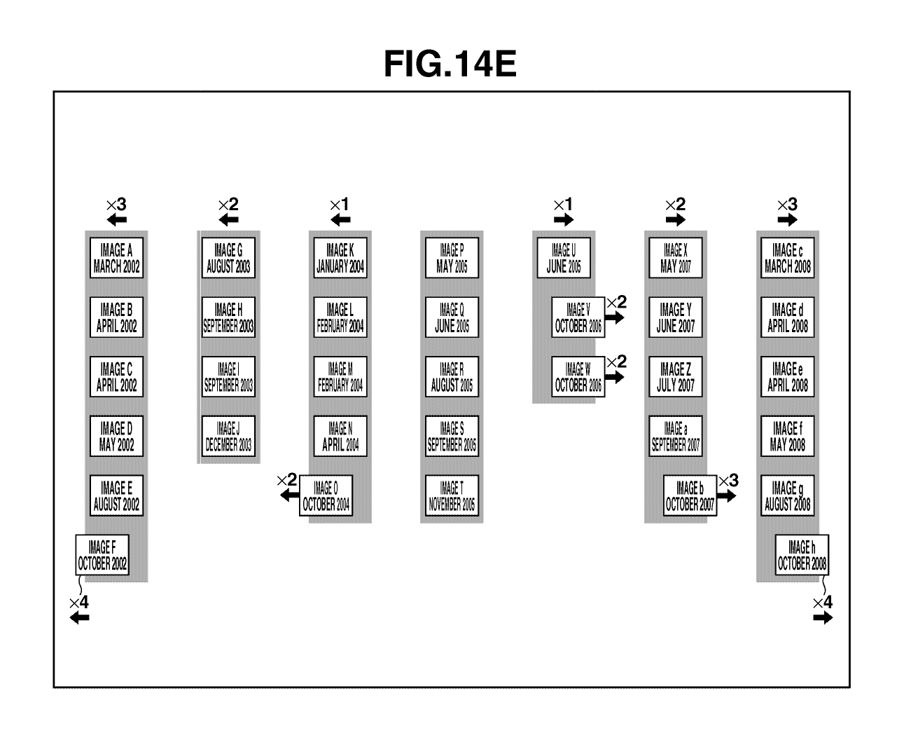

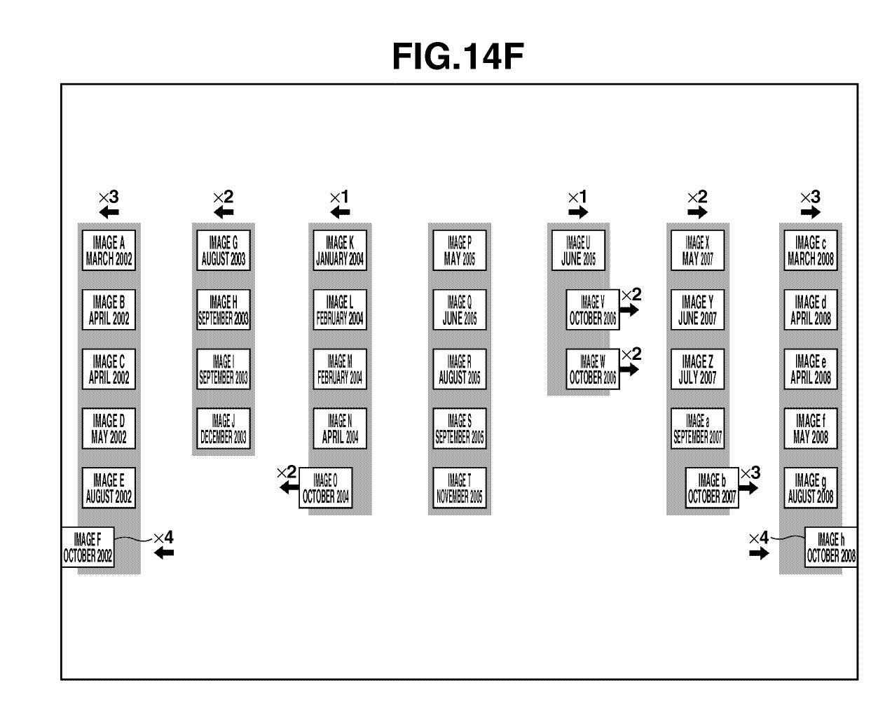

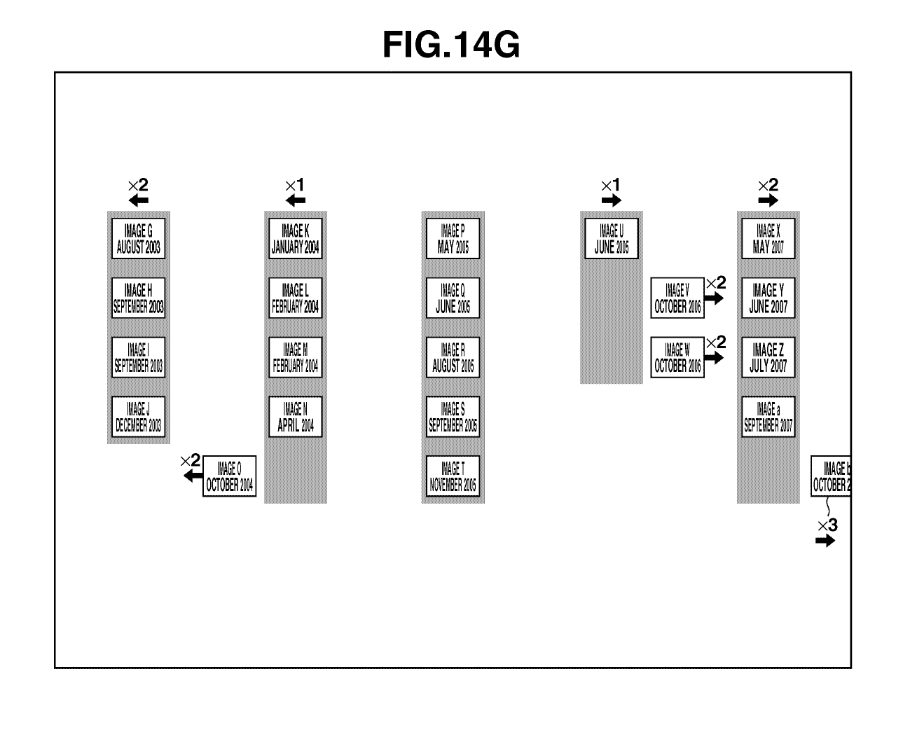

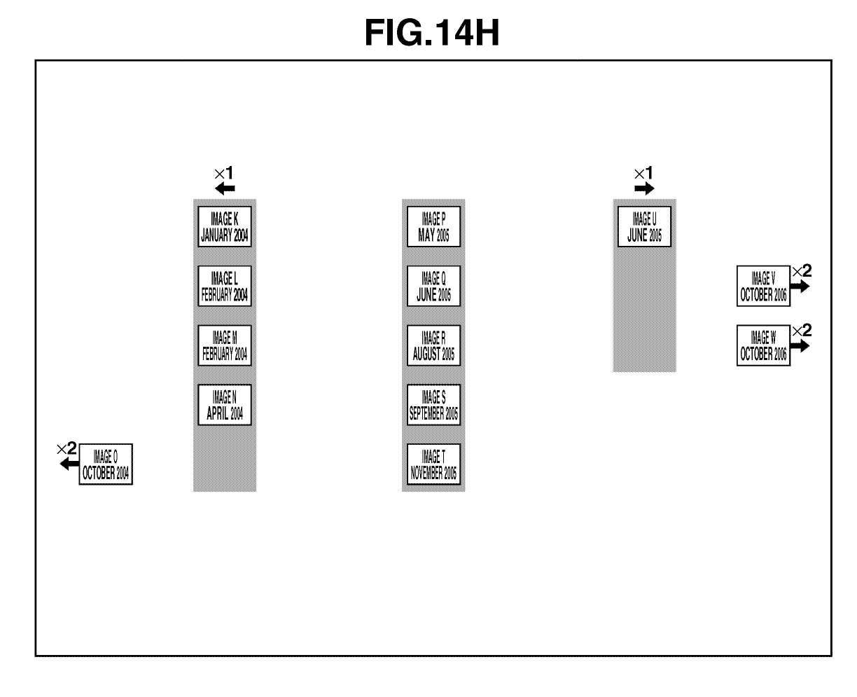

FIGS. 14A through 14H illustrate an example of a search for a desired image if image searching processing is executed according to the search condition “year 2005” and then the user has newly input the search condition “October” during the image search.

In the example illustrated in FIG. 14A, thirty-four search target images, which are displayed on the display unit 102 as a list as a result of the processing in step S301, are displayed.

When the processing in step S305 is executed, the search target images are grouped and displayed in the unit of a year as illustrated in FIG. 14B.

Then the processing in step S306 is executed, the CPU 201 determines the timing for starting the image deletion processing and the speed of deleting the images from the display unit 102 for each group as illustrated in FIG. 14C.

In the present exemplary embodiment, a publicly known fadeout animation effect is used in deleting the images. The images included in each groups are deleted at the same timing.

In addition, the CPU 201 determines the image deletion speed in the ascending order of chronological difference from the search condition “year 2005”. More specifically, for the “year 2004” group and the “year 2006” group, the CPU 201 sets the deletion speed so that the images included therein are deleted from the display unit 102 in twelve seconds from the start of the deletion processing. Further, for the “year 2003” group and the “year 2007” group, the CPU 201 sets the deletion speed so that the images included therein are deleted from the display unit 102 in six seconds from the start of the deletion processing. For the “year 2002” group and the “year 2008” group, the CPU 201 sets the deletion speed so that the images included therein are deleted from the display unit 102 in four seconds from the start of the deletion processing.

In other words, if the deletion speed of the images included in the “year 2004” group and the “year 2006” group from the display unit 102 is taken as a reference speed (normal deletion speed), then the deletion speed of those included in the “year 2003” group and the “year 2007” group is twice as high (hereinafter simply referred to as a “double deletion speed”). Similarly, the deletion speed of images included in the “year 2002” group and the “year 2008” group is three times as high (hereinafter simply referred to as a “triple deletion speed”).

The processing executed if the user newly inputs information “October” as the search condition in step S1303 will be described in detail below.

In the present exemplary embodiment, newly input information is used as information for preferentially deleting the images corresponding to the newly input information. Accordingly, it is also useful if a dialog message such as “Please designate unnecessary image(s).” on the display unit 102.

In step S1304, the CPU 201 changes the deletion speed of the images that satisfy the search condition “October”.

In changing the image deletion speed, if an image exists that is included in a group to which the double deletion speed has been set and satisfying the search condition “October”, then the CPU 201 sets the triple deletion speed to the image. On the other hand, if an image exists that is included in a group to which the normal deletion speed has been set and satisfying the search condition “October”, then the CPU 201 sets the double deletion speed to the image.

FIGS. 14E through 14H illustrate an example of processing after the image deletion speed has been changed in step S1304.

If the screen displayed in FIG. 14H is displayed on the display unit 102, then the CPU 201 executes the processing in step S1301 and suspends the image deletion processing. Then, in step S1305, the CPU 201 arranges and displays thirteen images on the display unit 102. In displaying the thirteen images on the display unit 102, the display unit 102 displays the images in a magnified state larger than the size of each image illustrated in FIG. 14H according to a number of the images.

It is also useful if information to be newly input is information for preferentially displaying the images corresponds to the information. Accordingly, a dialog message “Please designate a necessary image.” may be displayed on the display unit 102.

In this case, in step S1304, the CPU 201 changes the image deletion speed so that the deletion speed of the images that satisfy the newly input search condition is reduced.

According to the present exemplary embodiment having the above-described configuration, the user can effectively extract the desired image by inputting a new search condition during processing for narrowing down to a desired image.

Now, a fifth exemplary embodiment of the present invention will be described in detail below. If the user enters a new search condition while executing the image deletion processing, the present exemplary embodiment changes the image deletion speed. The functional components of the information processing apparatus according to the present exemplary embodiment is similar to those of the information processing apparatus of the first exemplary embodiment described above with reference to FIG. 1. Further, a flow chart illustrating exemplary processing executed by the information processing apparatus according to the present exemplary embodiment is similar to that described above with reference to FIG. 13. Accordingly, the description thereof will not be described in detail again here.

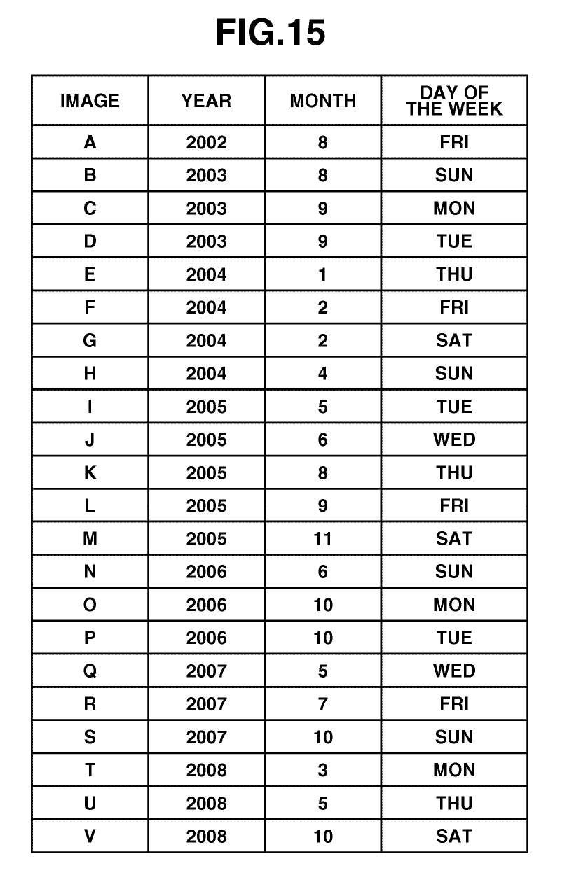

In the present exemplary embodiment, it is supposed that the user searching for a desired image from among twenty-two images illustrated in FIG. 15, which processing being essential to the present exemplary embodiment. Further, it is supposed that information about the year, the month, and the day has previously been added to each image illustrated in FIG. 15.

In step S302, the CPU 201 acquires information equivalent to the search condition input by the user via the input unit 103. It is supposed in the present exemplary embodiment that the information “year 2005” has been acquired.

In step S303, the grouping unit 104 groups the images in the unit of a numerical value included in the search condition. In the present exemplary embodiment, the grouping unit 104 groups the images in the unit of a year.

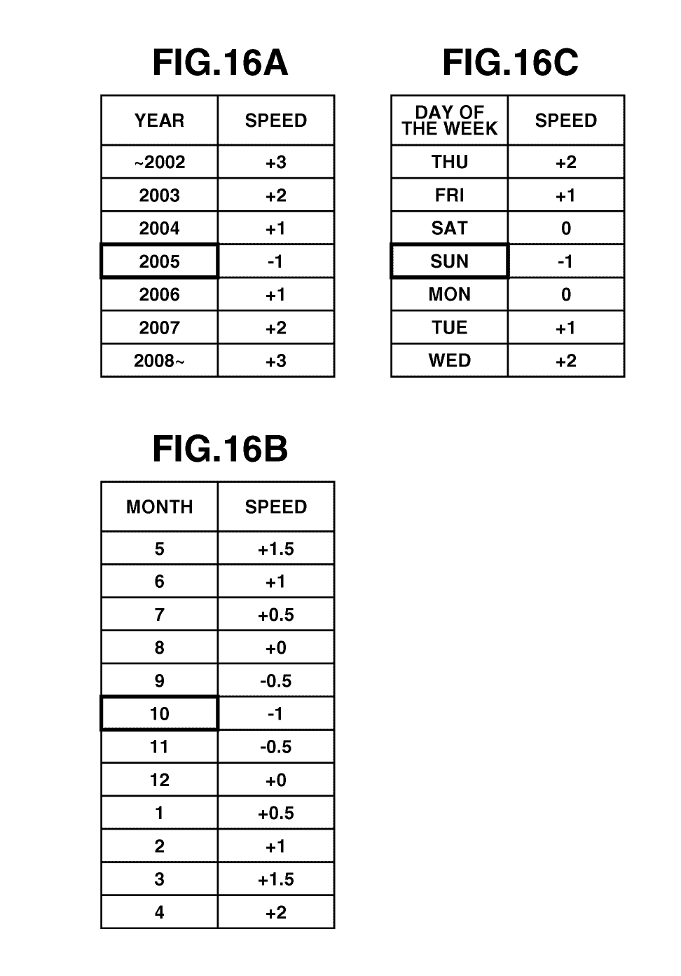

In step S304, the order setting unit 105 sets an order to each group according to the acquired search condition and the information about the group. In the present exemplary embodiment, the order setting unit 105 sets the information (speed) illustrated in FIG. 16A to each yearly group.

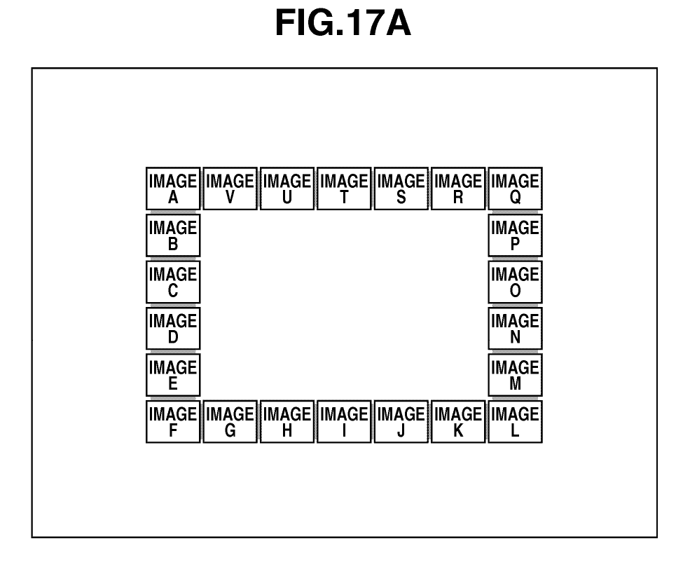

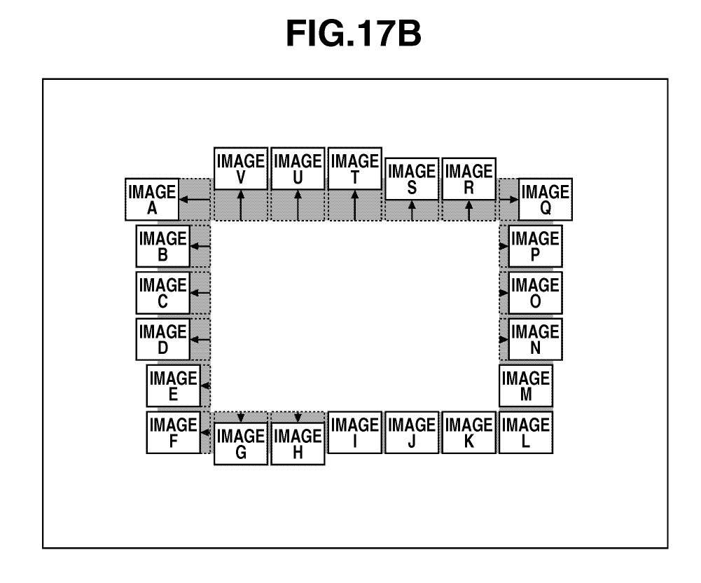

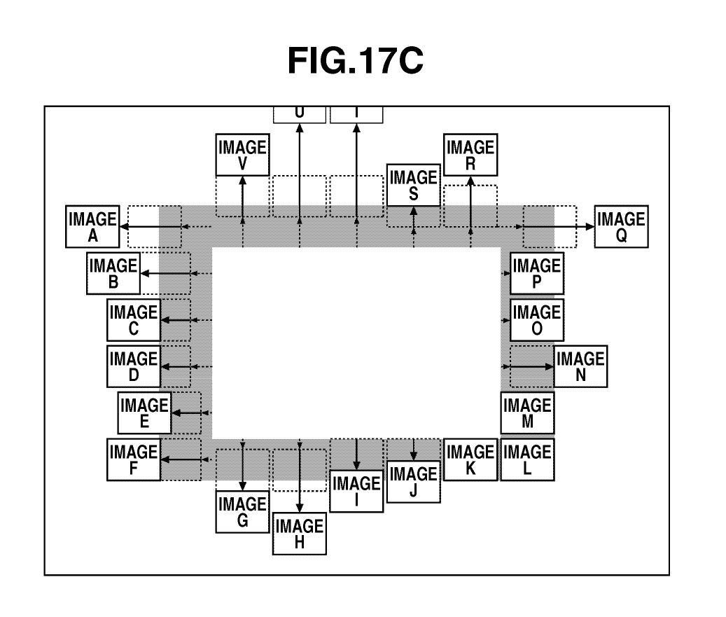

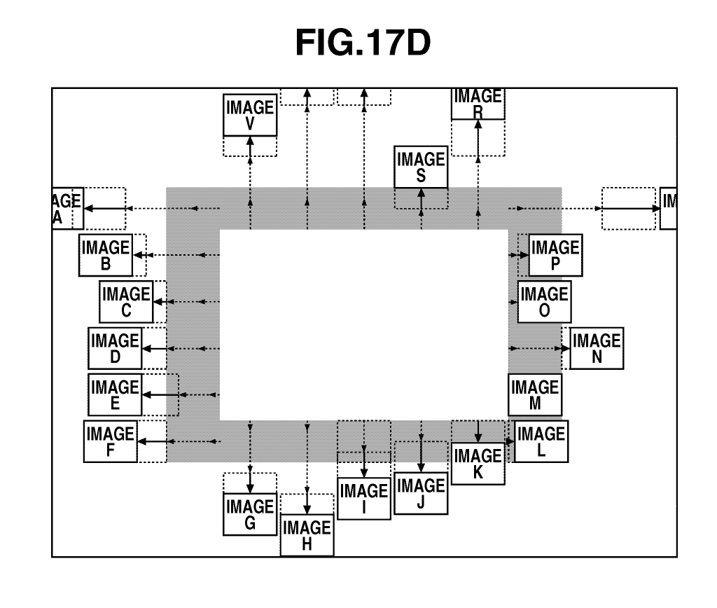

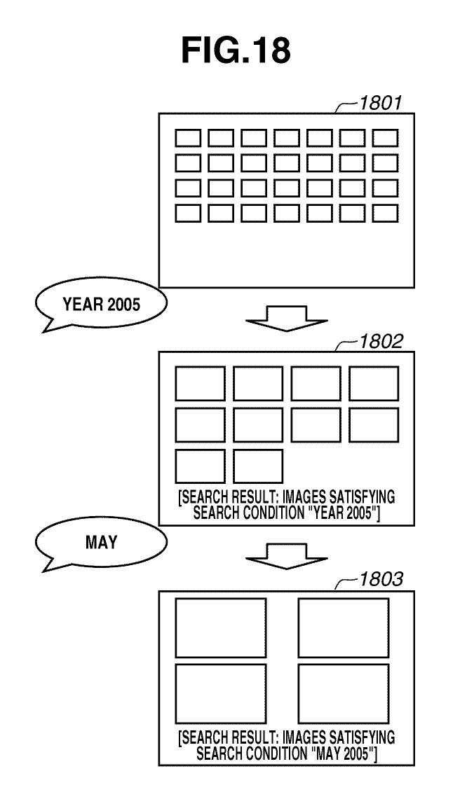

In step S305, the arrangement unit 106 arranges the images so that a plurality of images is displayed on the display unit 102 group by group. In the present exemplary embodiment, twenty-two images are arranged as illustrated in FIG. 17A. Further, the images are arranged in a counterclockwise order starting in the ascending chronological order from the “year 2002” group, to the “year 2003” group, then to the “year 2004” group, and the like.

In step S306, the deletion unit 107 sets the speed of deleting the images included in the group that does not satisfy the search condition according to the order set by the order setting unit 105. In the present exemplary embodiment, the order set by the order setting unit 105 in step S304 is used as the speed to be set in step S306 as it is. Further, in the present exemplary embodiment, the deletion unit 107 deletes the images from the display unit 102 by utilizing the publicly known animation effect as fadeout.

In step S307, the deletion unit 107 displaces the images included in the group that does not satisfy the search condition outside the display area of the display unit 102 according to the above-described speed.

FIG. 17B illustrates processing for deleting the images that do not correspond to information “year 2005” (first information) (first image deletion processing).

The processing executed if the user newly inputs information “October” as a search condition in step S1303 will be described in detail below. In the present exemplary embodiment, newly input information is used as information for preferentially reserving the images corresponding to the newly input information.

If the information “October” (second information) is input, the processing advances to step S1304. In step S1304, the CPU 201 sets a new speed for each month. In the present exemplary embodiment, the speed described above with reference to FIG. 16B is added to the predetermined speed. In other words, the present exemplary embodiment resets the image deletion speed.

FIG. 17C illustrates an example of processing for deleting the images that do not satisfy search conditions “year 2005” and “October” (second deletion processing).

If the image deletion speed to be set to an image becomes equal to or below “0” as a result of the resetting thereof, the CPU 201 sets a value “0” as the deletion speed value set to the image.

The processing which is executed when the user has newly input a search condition “Sunday (SUN)” in step S1303 is described below. In the present exemplary embodiment, newly input information is used as information for preferentially reserving the images corresponding to the newly input information.

If the information “Sunday (SUN)” (third information) is input by the user, then the processing advances to step S1304. In step S1304, the CPU 201 sets a new speed for each day. In the present exemplary embodiment, the speed described above with reference to FIG. 16C to the predetermined speed. In other words, the present exemplary embodiment resets the image deletion speed.

FIG. 17D illustrates an example of processing for deleting the images that do not satisfy search conditions “year 2005”, “October”, and “Sunday” (third deletion processing).

If the image deletion speed to be set to an image becomes equal to or below “0” as a result of the resetting thereof, the CPU 201 sets a value “0” as the deletion speed value set to the image.

If a search condition not to be included in categories such as “year”, “month”, or “day of the week” (e.g., information such as “athletic meeting”) is input by the user, then the processing advances to step S1304. In step S1304, if an image satisfying the search condition exists, the CPU 201 decrements the predetermined speed for the image by 1. On the other hand, if an image that does not satisfy the search condition exists, the CPU 201 increments the predetermined speed for the image by 2.

If the image deletion processing is suspended in step S1301, then the processing advances to step S1305. In step S1305, the CPU 201 arranges and displays the images which are displayed on the display unit 102 when the image deletion processing is suspended on the display unit 102 as the search result.

With the above-described configuration, the present exemplary embodiment, the user can effectively extract the desired image by inputting a new search condition during processing for narrowing down to a desired image.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-304599, filed Nov. 28, 2008, which is hereby incorporated by reference herein in its entirety.

What is claimed is:

1. An information processing apparatus comprising:
a display control unit configured to cause a display unit to display a plurality of images;
an input unit configured to input information for designating a part of the plurality of images;
a setting unit configured to set a speed or a timing of deleting each image according to a degree of relativity of each image with the input information; and
a deletion unit configured to delete the images from the display unit according to the speed or the timing set by the setting unit.

2. The information processing apparatus according to claim 1, further comprising:
a grouping unit configured to group the plurality of images into a plurality of groups,
wherein the display control unit is configured to display a plurality of images included in each group,
wherein the setting unit is configured to set the degree of relativity of each image included in each group with the information, and
wherein the deletion unit is configured to serially delete images starting from the images included in the group whose degree of relativity of the images with the input information is low.

3. The information processing apparatus according to claim 1,
wherein while executing deletion of the images by the speed set according to the degree of relativity of the images with first information by using the deletion unit, if second information is input, the setting unit is configured to reset the speed of deleting each image according to the degree of relativity with the second information, and
wherein the deletion unit is configured to delete the images according to the speed reset by the setting unit.

4. The information processing apparatus according to claim 1, wherein an animation effect is used in deleting an image to be deleted from the display unit.

5. The information processing apparatus according to claim 4, wherein the image to be deleted is deleted while being moved on a screen of the display unit.

6. The information processing apparatus according to claim 5, wherein the lower the degree of relativity of the image to be deleted with the input information is, the faster the image to be deleted is moved according to the degree of relativity during the deletion processing.

7. The information processing apparatus according to claim 1, further comprising a suspension unit configured to suspend the processing for deleting the image while the deletion unit deletes the image.

8. A method for processing information comprising:
controlling a display unit to display a plurality of images;
inputting information for designating a part of the plurality of images;
setting a speed or a timing of deleting each image according to a degree of relativity of each image with the input information; and
deleting the images from the display unit according to the set speed or timing.

9. A computer-readable storage medium storing instructions which cause a computer to perform operations included in the method according to claim 8.
